(19) United States
(12) Patent Application Publication
(10) Pub. No.: US 2020/0318571 A1
(43) Pub. Date: Oct. 8, 2020

(54) FUEL INJECTOR CONTROL USING NOISE SIGNAL

(71) Applicant: Delphi Automotive Systems Luxembourg SA, Bascharage (LU)

(72) Inventors: Noureddine GUERRASSI, Vineuil (FR); Maxime VIOULAC, Luxembourg (LU)

(21) Appl. No.: 16/650,552

(22) PCT Filed: Sep. 24, 2018
(86) PCT No.: PCT/EP2018/075767

§ 371 Date: Mar. 25, 2020

(30) Foreign Application Priority Data
Sep. 25, 2017 (GB) 1715504.5

(51) Int. Cl. F02D 41/40; F02M 51/06; F02M 61/10; F02M 61/18; F02M 51/00; F02M 57/00; F02M 65/00

(52) U.S. Cl. CPC F02D 41/40; F02M 51/061; F02M 61/10; F02M 63/0017; F02M 51/005; F02M 57/005; F02M 65/005; F02M 61/1853

(57) ABSTRACT

A fuel injector includes a noise sensor fixed to the body fixed on the injector body to record knocks relevant to the end travel of a control valve and of a needle.

### CROSS REFERENCE TO RELATED APPLICATIONS

This application is a national stage application under 35 USC 371 of PCT Application No. PCT/EP2018/075767 having an international filing date of Sep. 24, 2018, which is designated in the United States and which claimed the benefit of GB Patent Application No. 1715504.5 filed on Sep. 25, 2017, the entire disclosures of each are hereby incorporated by reference in their entirety.

### TECHNICAL FIELD

The present invention relates to a fuel injector closed loop control method.

### BACKGROUND OF THE INVENTION

Closed loop control is a major improvement in fuel injection equipment wherein an electronic command unit constantly adjusts the command signals it sends to the injectors as a function of sensor signals received from said injectors and representative of the actual operation of the injector. Several embodiments for arranging sensors on a injector have been proposed and EP1961952 proposes, with no specific details, the concept of a sensor module grouping several sensors on the top end of a fuel injector body.

Application GB1710526.3, filed 30 Jun. 2017, proposes to arrange a noise sensor in a fixation bush of the electrical connector of the injector, said sensor comprising a piezoelectric washer sandwiched and compressed between a base washer and spring washers. The control method itself is not precisely detailed.

### SUMMARY OF THE INVENTION

Accordingly, it is an object of the present invention to resolve the above mentioned problems in providing a fuel injector comprising a body in which an electrovalve cooperates with a needle valve member to enable or to prevent fuel injection. The electrovalve moves, in use, to open or to close a spill orifice to vary the pressure in a control chamber and, the needle valve member moving under the influence of said control chamber pressure to open or to close spray holes. The body is hit, in use, by the electrovalve when reaching a closed position of said spill orifice and also when reaching a fully open position of said orifice. The body is hit also by the needle valve member when reaching a closed position said spray holes and also when reaching a fully open position of said holes. Said hits are recorded by a noise sensor fixed to the body, said sensor generating a signal representative of said hits.

The fuel injector further comprises a three-terminals electric connector, two of terminals being connected to the electrovalve, the third terminal being connected to the noise sensor.

Also, the noise sensor comprises a piezo ceramic washer compressed between a base and a ground metal washer, said piezo washer being connected to said third pin.

The invention further extends to a fuel injection equipment of an internal combustion engine comprising a plurality of fuel injectors as mentioned above and also, an electronic command unit (ECU) adapted to control the equipment and to execute a closed loop control method.

The invention is also about the ECU adapted to control a fuel injection equipment mentioned above.

The invention is also about a method to control a fuel injector as mentioned above, said method comprising a reference phase performed when the injector is new, said reference phase comprising the steps of:
measuring reference injection events timings and storing said values in a memory of a command unit;

and, an operational phase performed during the life time of the injector, said operational phase comprising the steps of:
recording the rough signal of the noise sensor;
integrating said rough signal to generate a cumulative signal as and when;
identifying slope variations in said cumulative signal, said slope variations being representative of a knock;
determining actual injection events timings;
comparing the actual values with the reference values;
calculating the electrovalve command drive pulse correction data;
adjusting the fuel quantity of the following injection event by adjusting the electrovalve control drive pulse duration.

The operational phase further comprises the step:
storing the correction data in the memory of the ECU for subsequent fuelling control correction to ensure long term vehicle emissions stability.

Also, during the identifying step:
the first slope variation is representative of the electrovalve reaching the fully open position and,
the second slope variation is representative of the needle valve member reaching the fully open position and,
the third slope variation is representative of the electrovalve reaching the closed position and,
the fourth slope variation is representative of the needle valve member reaching the closed position.

### BRIEF DESCRIPTION OF THE DRAWINGS

The present invention is now described by way of example with reference to the accompanying drawings in which:

FIG. 1 is a schematic of a fuel injection equipment with closed loop control.

FIG. 2 is a schematic of fuel injector of the equipment of FIG. 1, atop said injector being fixed an electrical connector integrating a noise sensor as per the invention.

FIGS. 3, 4 and 5 are views and section of an injector as in FIG. 2.

FIGS. 6, 7, 8 and 9 are sections of the injector detailing areas generating knock signals.

FIG. 10 is a rough signal of the noise sensor during operation of the injector.

FIG. 11 is the integral of the noise voltage of FIG. 10 analysed to control the operation of the injector.

### DESCRIPTION OF THE PREFERRED EMBODIMENTS

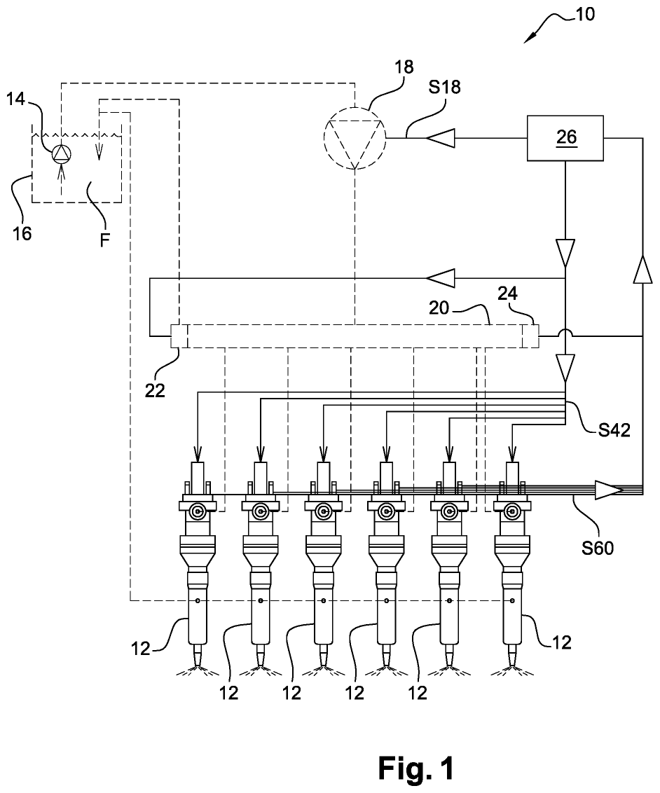

The schematic of a diesel fuel injection equipment 10 of an internal combustion engine is shown on FIG. 1, the hydraulic circuits being represented in dotted lines and the control being in solid lines.

The equipment 10 shown has six fuel injectors 12 and, in following the hydraulic stream flow direction, fuel F is drawn from a tank 14 by a feed pump 16 and is delivered to a high pressure pump 18, wherein said fuel is pressurised and sent to a high pressure common rail 20. The pressure in the rail 20 is controlled by a high pressure discharge valve 22 associated to a pressure sensor 24 and, depending on the pressure measured, the high pressure discharge valve 22 closes or opens a return line for fuel in excess to return to the tank 14 and to lower the rail internal pressure. Another valve, not represented, arranged at the inlet of the high pressure pump 18 is also used for the rail pressure control. The fuel F remaining in the rail 20 is delivered to the six injectors 12, part of which being sprayed to fulfill the engine torque and power requirements, the other part serving to operate the injectors and being afterward returned to the tank 14 via another return line.

Many other hydraulic architecture are known with more or less injectors depending on the engine, or without rail, the injectors being directly fed by the pump in rail-less equipment's.

The equipment 10 is controlled by an electronic control unit 26, here after ECU, which executes a closed loop method 100.

In addition to the engine operational data and requirements, the ECU 26 receives signals from the injectors 12 and from the pressure sensor 24 and, said signals received are integrated in the computation of command signals sent to the valve 22, to said another valve at the inlet of the pump 18 and to the injectors 12.

For instance, should the rail inner pressure measured by the sensor 24 and sent to the ECU 26 be lower than what is required by the engine, the ECU sends to the valve 22 a command signal to close the return line so the inner pressure can rise to the required level. To the contrary, should the rail inner pressure measured by the sensor 24 be too high, the ECU sends to the valve a command signal to open said return line for fuel in excess to return to the tank and for the rail inner pressure to drop.

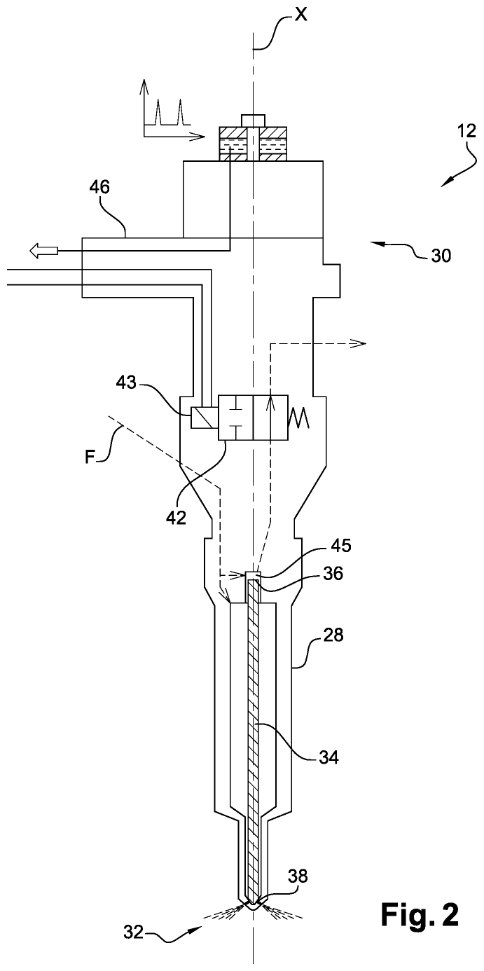

A diesel fuel injector 12 is sketched on FIG. 2 and it comprises an elongated body 28 extending along a longitudinal axis X and adapted to be inserted in a well provided in the engine block. Said body 28 extends between a top end 30 that remains, in use, outside the well, to a tip end 32 that is inside the well and wherefrom fuel is sprayed in a cylinder of the engine. In said body 28 is arranged a needle valve member 34 axially X guided in a bore between a closed position CPN, where fuel injection is prevented and, a fully open position OPN where injection is enabled. Said needle 34 extends between a head defining an upper stop face 36 and, a tip end defining a closing face 38.

In closed position of the needle CPN, the closing face 38 is urged in sealing contact against a needle seat 40 defined in the body thus preventing fuel injection through the spray holes opening downstream said seat. When opening, the closing face 38 lifts away from the seat 40 enabling fuel injection and, when getting to the fully open position of the needle OPN the stop face 36 abuts against a complementary stop face 41 of the body that stops the upward move of the needle.

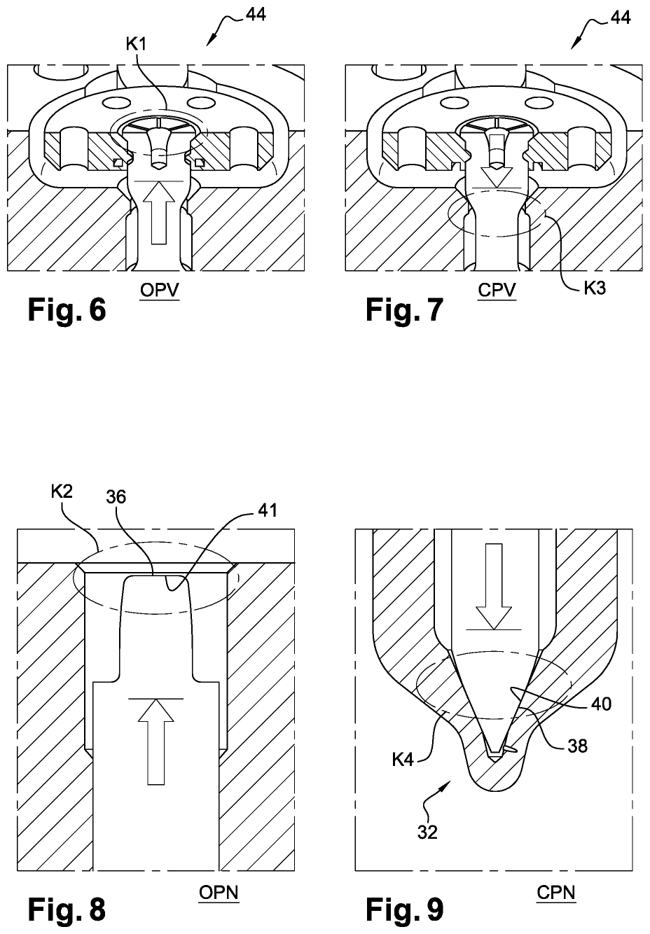

To move the needle from a position to the other an electrovalve 42 is commanded to move between a fully open position OPV and a closed position CPV, respectively opening and closing a spill orifice for enabling or preventing fuel captured in a control chamber 45, wherein the needle head extends, to exit and return toward the tank. The electrovalve 42 has a body in which a solenoid 43 cooperates with a magnetic armature-and-stem assembly 44. When being energised, the solenoid generates a magnetic field attracting the armature-and-stem assembly 44 toward said open position OPV. When reaching the closed position CPV (FIG. 7) the stem knocks the valve body closing a valve seat obturating said spill orifice and, when reaching the fully open position OPV (FIG. 6) the armature-and-stem 44 assembly comes in contact and knocks another face of the injector body. In closed position of the valve CPV the pressure rises in the control chamber 45 urging the needle toward the closed position CPN and, when the electrovalve 42 opens OPV the spill orifice, the pressure drops in the control chamber 45 and the needle lifts toward the open position OPN.

At both extremities of the displacement, a face of the needle hits a face of the body. In closed position CPN, the closing face 38 knocks on the seat 40 (FIG. 9) and, in fully open position OPN (FIG. 8) the stop face 36 of the needle knocks against the complementary stop face 41 of the body. Said knocks K, symbolized on the figures by a circle drawn in the area of the contacting parts, generate a sound wave that propagates in the body along the axial direction X.

The fuel injector further comprises a noise sensor 60 arranged on the injector body. In the embodiment presented, said sensor 60 is compressed between the injector body and a screw head 58, the sensor generating a signal S60 relevant of the knocks K of the needle reaching the closed position CPN or the fully open position OPN and also, of the knocks of the valve reaching the closed position CPV or the fully open position OPV. Said knocks K sound wave travel extremely quickly in the body and the signal S60 is generated quasi simultaneously to the hit generating said knock.

The noise sensor 60 comprises an active piezoelectric member 62 sandwiched between a steel base member 64 and a steel seismic member 66. The base member 64 is against the injector body and is electrically isolated from the injector body by an isolation washer 68 while the seismic member 66, on the opposite side of the piezo-member, is just under the screw head 58 and is electrically connected to the injector body and to the electric ground via said screw 56. Said three members are washers centrally holed so the fixation screw 56 to extend.

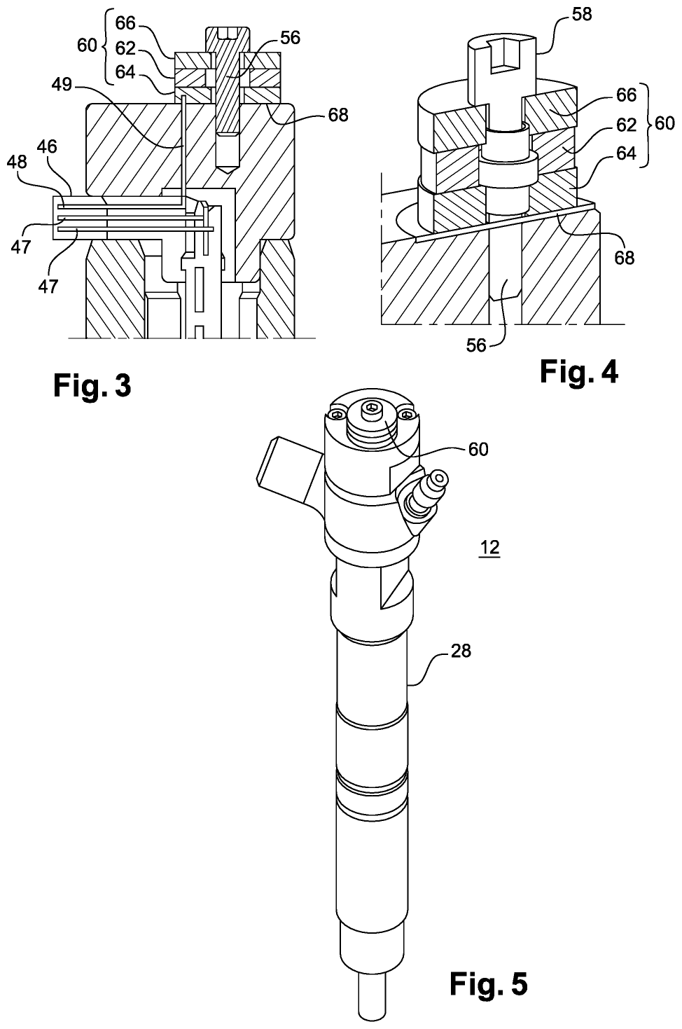

The injector further comprises an electric connector 46 having two terminals 47 used to connect the solenoid 43 and, a third terminal 48 to connect the noise sensor 60 and, as shown on FIG. 3 the electric connector being arranged by the top end of the injector a short wire 49 inter-connects the noise sensor 60 to said third terminal 48. In a preferred embodiment, said electric connector 46 comprises three terminals only, meaning not more than three terminals.

Key steps of the injector operation are now described.

In a preliminary first step, the solenoid 43 is not energised, the valve is in closed position CPV and the needle is in closed position CPN.

In a subsequent second step, the ECU 26 sends an opening command signal which forces the valve to move to the open position OPV. When reaching said fully open position OPV, a first knock K1 is generated.

As the spill orifice is open, the control chamber pressure drops and the needle moves to the open position OPN. When reaching said fully open position OPN a second knock K2 is generated.

In a third step, the ECU ends energisation of the solenoid and, pushed by a spring, the valve moves back to the closed position CPV. When reaching said closed position, a third knock K3 is generated.

As the spill orifice is now closed the control chamber pressure rises again and the needle moves back toward the closed position CPN. When reaching said closed position CPN, a fourth knock K4 is generated.

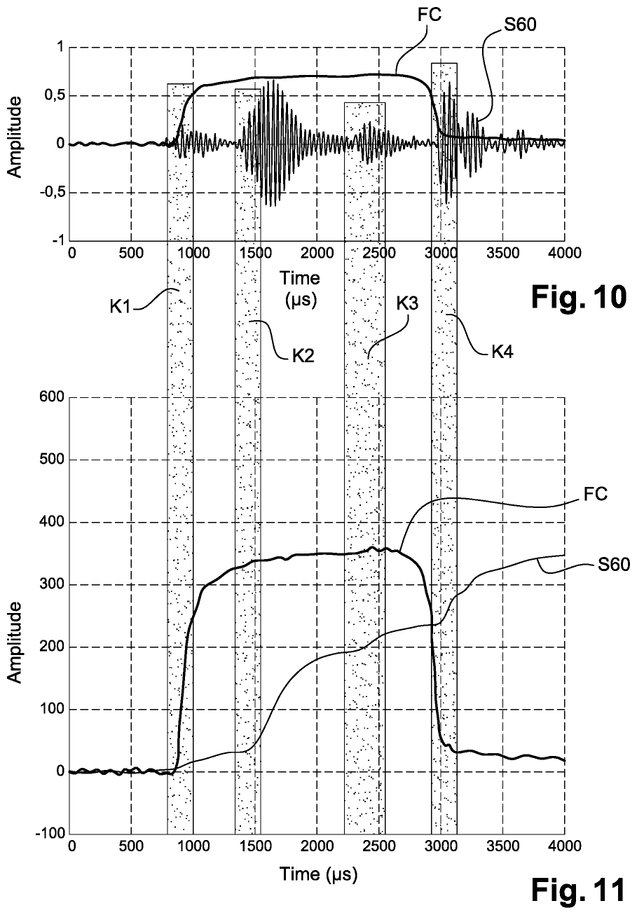

FIGS. 10 and 11 are linked as FIG. 10 shows the rough sensor signal S60 and FIG. 11 shows the cumulative signal S60.

In reference to FIG. 10 is shown on a X-Y graph, the X-axis being the time in microseconds (μs) and the Y-axis being in volts (V), a plot made in a laboratory of the rough signal S60 generated by the sensor 60 and, a plot representative of the actual fuel quantity injected usually called fuel injection rate or Rate of Injection abbreviated ROI.

FIG. 11 shares with FIG. 10 the same X-axis and shows the cumulative curve of the sensor signal S60, which is then much smoother, each of the four knocks K1-4 being well identified by a change in slope. Thereon can be identified time-areas wherein occurs said knocks:

the first knock K1 occurs at about 800 μs,

the second knock K2 at about 1400 μs,

the third knock K3 at about 2400 μs and,

the fourth knock K4 at about 3000 μs.

Also, following the X-time axis, the injection duration (plot FC) is about 2200 μs, from 800 μs to 3000 μs. Starting the injection (FC) at 800 μs indicates that actual opening of the valve occurred even earlier, the first knock K1 only indicating the end of travels of the valve. The start of opening of the valve is known since it corresponds to the opening command signal by the ECU to the solenoid. Determination of the first knock K1 enables to determine precisely the opening travel time of the valve.

Also, to end the injection at 3000 μs, the valve must be closed CPV about 600 μs before.

During its life operation, the characteristics of the injector will drift because of wear of the parts. The closed loop method 100 aims at taking into account that drift into a correction factor in order to always inject the desired fuel quantity.

The closed loop control method 100, comprises the following steps:
before all (reference phase A), when the injector is new, before installing the injector on an engine, reference values are measured on a test bench and are stored in the ECU (method step A1). Said reference values map several operational conditions, with fuel pressure, engine RPM, engine torque requirement. For each of said operational condition is stored the fuel quantity injected, or reference quantity of fuel injected; the opening time duration of the valve, the timing duration between each of the knocks K1-4.
then, when installed on an engine (operational phase B), running during the operational life of the injector, the rough sensor signal S60 is recorded (method step B1) in the ECU and the cumulative curve of the signal is generated (method step B2). Said cumulative curve is then analyzed to identify slope sudden variations (method step B3), said variations being representative of the knocks K1-4. Timing durations between each of the knocks K1-4 are afterward determined (method step B4) and are then compared (method step B5) to the reference values stored at step Al. If the injector has aged and a drift has occurred, the ECU calculates a corrected drive pulse (method step B6) and, at the following cycle, the command signal sent to the valve are adjusted (method step B7) so that the fuel quantity injected remains, as close as possible, equal to the reference quantity although the injector is worn.

For instance, if at step Al was stored a reference duration timing between the first knock K1 and the second knock K2 of 600 μs (1400 μs-800 μs) and if an actual duration is determined to be 650 μs then a drift of 50 μs has happened and, to compensate for said drift, the opening command of the valve should be sent 50 μs earlier in order to correct the injection timing within the engine thermodynamics cycle.

The drift in timing duration happens mainly because of mechanical wear of the parts, therefore said drift is not a punctual event, it remains and is repeated and, that is why after said correction data has been calculated, it is stored and applied automatically in the following injection cycles (method step B8).

### LIST OF REFERENCES

F fuel
X longitudinal axis
S18 command signal sent to the pump
S42 command signal sent to the electrovalve
S60 signal generated by the sensor
ROI rate of injection—fuel quantity
K knock
CPN closed position of the needle
OPN open position of the needle
CPV close position of the valve
OPV open position of the valve
10 fuel injection equipment
12 injector
14 tank
16 feed pump
18 high pressure pump
20 common rail
22 high pressure discharge valve
24 pressure sensor
26 electronic control unit—ECU
28 injector body
30 top end of the body
32 tip end of the body
34 needle valve member
36 stop face of the needle
38 closing face of the needle
40 needle seat of the body
41 complementary stop face of the body
42 electrovalve
43 solenoid
44 armature-and-stem assembly
45 control chamber
46 electrical connector
47 terminals to connect the solenoid
48 terminal to connect the noise sensor
49 wire
56 fixation screw
58 screw head
60 noise sensor
62 piezoelectric member
64 base member
66 seismic member—ground washer
68 isolation washer
100 method
A reference phase
Al generating and storing reference values
B operational phase
B1 recording
B2 integrating
B3 identifying
B4 determining
B5 comparing
B6 calculating
B7 adjusting
B8 storing

1-8. (canceled)

9. A fuel injector comprising:
a body;
an electrovalve in the body which cooperates with a needle valve member to enable or to prevent fuel injection, the electrovalve moving to open or to close a spill orifice to vary pressure in a control chamber, the needle valve member moving under the influence of said pressure in the control chamber to open or to close spray holes; and
a noise sensor fixed to the body;
wherein the body is hit by the electrovalve when the electrovalve reaches a closed position relative to the spill orifice and when the electrovalve reaches a fully open position relative to the spill orifice;
wherein the body is also hit by the needle valve member when the needle valve member reaches a closed position relative to the spray holes and when the needle valve member reaches a fully open position relative to the spray holes; and
wherein the noise sensor is configured to record the hits of the electrovalve and of the needle valve member and generate a signal representative of the hits of the electrovalve and of the needle valve member.

10. A fuel injector as claimed in claim 9, further comprising an electrical connector with three terminals, wherein a first terminal and a second terminal of the three terminals are connected to the electrovalve and a third terminal of the three terminals is connected to the noise sensor.

11. A fuel injector as claimed in claim 10, wherein the noise sensor comprises a piezo ceramic washer compressed between a base and a ground metal washer, said piezo ceramic washer being connected to the third terminal.

12. Fuel injection equipment of an internal combustion engine, said fuel injection equipment comprising:
a plurality of fuel injectors, wherein each of said plurality of fuel injectors comprises:
a body;
an electrovalve in the body which cooperates with a needle valve member to enable or to prevent fuel injection, the electrovalve moving to open or to close a spill orifice to vary pressure in a control chamber, the needle valve member moving under the influence of said pressure in the control chamber to open or to close spray holes;
a noise sensor fixed to the body;
wherein the body is hit by the electrovalve when the electrovalve reaches a closed position relative to the spill orifice and when the electrovalve reaches a fully open position relative to the spill orifice;
wherein the body is also hit by the needle valve member when the needle valve member reaches a closed position relative to the spray holes and when the needle valve member reaches a fully open position relative to the spray holes; and
wherein the noise sensor is configured to record the hits of the electrovalve and of the needle valve member and generate a signal representative of the hits of the electrovalve and of the needle valve member; and
an electronic command unit configured to control the fuel injection equipment and execute a closed loop control method.

13. A method to control a fuel injector as claimed in claim 1, said method comprising:
a reference phase performed when the fuel injector is new, said reference phase comprising measuring reference injection events timings and storing resulting reference values in a memory of a command unit; and
an operational phase performed during a life time of the injector, said operational phase comprising the steps of:
B1) recording a rough signal of the noise sensor;
B2) integrating said rough signal to generate a cumulative signal;
B3) identifying slope variations in said cumulative signal, said slope variations being representative of knock;
B4) determining actual injection events timings;
B5) comparing the actual event timings with the reference values;
B6) calculating electrovalve command drive pulse correction data;
B7) adjusting fuel quantity of a following injection event by adjusting an electrovalve control drive pulse duration.

14. A method as claimed in claim 13 wherein the operational phase further comprises storing the electrovalve command drive pulse correction data in the memory of the command unit for subsequent fuelling control correction which ensures long term vehicle emissions stability.

15. A method as claimed in claim 13, wherein, during step B3):
a first slope variation is representative of the electrovalve reaching the fully open position;
a second slope variation is representative of the needle valve member reaching the fully open position;
a third slope variation is representative of the electrovalve reaching the closed position and,
a fourth slope variation is representative of the needle valve member reaching the closed position.
